(19) United States
(12) Patent Application Publication
(10) Pub. No.: US 2008/0038051 A1
(43) Pub. Date: Feb. 14, 2008

(54) Ball and Socket Joint with a Sealing Bellows

(76) Inventors: Klaus Broker, Bohmte-Hunteburg (DE); Dirk Adamczyk, Lemforde (DE)

Correspondence Address: MCGLEW & TUTTLE, PC, P.O. BOX 9227, SCARBOROUGH STATION, SCARBOROUGH, NY, 10510-9227, US

(21) Appl. No.: 11/575,896

(22) PCT Filed: Sep. 21, 2005
(86) PCT No.: PCT/DE05/01664

§ 371 Date: Mar. 23, 2007

(30) Foreign Application Priority Data
Sep. 24, 2004 (DE) 10 2004 046 676.9

(51) Int. Cl. F16C 11/06

(52) U.S. Cl. 403/134

(57) ABSTRACT

A ball and socket joint has a sealing bellows (4) that is in contact with the surface (17) of the ball pivot (3) by means of a circumferential closing collar (11) in the shaft area (7) of the ball pivot (3). The ball and socket joint has an element (14), which is elastic in the axial direction of the pivot and may be designed as a compression spring element, arranged in the neck area (8) of the ball pivot (3). The compression spring element is supported with one end in the area of the transition between the neck area (8) and the ball (9) of the ball pivot (3) and with the other end indirectly or directly at the pivot-side closing collar (11) of the sealing bellows (4). The sealing bellows is permanently and reliably prevented from slipping off from the neck of the ball pivot even under extreme climatic conditions or in case of extraordinary mechanical stresses, for example, in case of exposure to the water jet of a high-pressure cleaner. In addition, the pivot-side seal of the sealing bellows as well as the control of the seal in terms of design and the dimensionability of the seal are improved.

### CROSS REFERENCE TO RELATED APPLICATIONS

This application is a United States National Phase application of International Application PCT/DE2005/001664 and claims the benefit of priority under 35 U.S.C. § 119 of German Patent Application DE 10 2004 046 676.9 filed Sep. 24, 2004, the entire contents of which are incorporated herein by reference.

### FIELD OF THE INVENTION

The present invention pertains to a ball and socket joint with a sealing bellows in contact with the surface of the ball pivot by means of a circumferential closing collar in the shaft area of the ball pivot.

### BACKGROUND OF THE INVENTION

Ball and socket joints of the type mentioned in the introduction are used, for example, but by no means exclusively, on the chassis or on the wheel suspension of motor vehicles.

Such a ball and socket joint is known, for example, from U.S. Pat. No. 2,397,464. This ball and socket joint has a joint housing, wherein a bearing shell is inserted into the interior space of the joint housing for receiving a joint ball arrangement arranged on a ball pivot in a slidingly movable manner. The ball pivot is connected or screwed to a connection component, for example, the lever holder of a control arm on the motor vehicle, in the usual manner.

To avoid the penetration of moisture and/or contaminants into the bearing area of the ball and socket joint, this prior-art ball and socket joint has a sealing bellows made of an elastomer material, which has two connection collars extending circumferentially in a ring-shaped pattern. The sealing bellows is connected to the edge of the joint housing by means of the two connection collars in the usual manner. The other connection collar is likewise in contact with the neck or the shaft of the ball pivot in the usual manner.

It happens in conventional ball and socket joints that the sealing bellows sags in the area of the connection collar, which is in contact with the ball pivot, or leaves its defined seat on the ball pivot and moves towards the joint housing. However, proper function of the sealing bellows and of the ball and socket joint is no longer guaranteed now. In particular, the sealing bellows, which is not seated correctly any longer, may be jammed between the edge of the joint housing and the ball pivot or the lever holder and subsequently damaged. Since the connection collar of the sealing bellows is no longer at its defined seat now, and since the sealing bellows is, moreover, for example, no longer in contact with the lever holder, the sealing action of the sealing bellows is, moreover, compromised, and corrosion may develop at first in the area of the now exposed shaft area of the ball pivot and more leaks will subsequently develop between the sealing bellows and the ball pivot.

Due to the entry of moisture and contaminants into the joint area of the ball and socket joint, which has become possible as a result, increased clearance of the bearing, sluggishness due to corrosion and even failure of the ball and socket joint will finally frequently develop.

According to the teaching of the document U.S. Pat. No. 2,397,464, an attempt is made at counteracting the problem of the sagging of the pivot-side collar of the sealing bellows, which is in contact with the lever holder, by a compression coil spring being arranged in the interior of the sealing bellows. The compression coil spring is supported with one end at the edge of the joint housing, the other end of the compression coil spring pressing the corresponding connection collar of the sealing bellows away from the joint housing in the direction of the lever holder.

At first, already the arrangement of the compression spring between the collar of the sealing bellows and the edge of the joint housing is not optimal, because the compression spring is forced due to this arrangement to follow all pivoting motions of the ball and socket joint, and a circumferentially uniform pressing pressure of the compression spring on the connection collar of the sealing bellows is guaranteed in the neutral position of the ball and socket joint only. The pressing pressure of the compression spring increases on one side of the circumference of the connection collar, whereas the pressing pressure on the respective opposite side of the connection collar decreases in all other angular positions, which may in turn compromise the correct fixation and the tightness of the sealing bellows.

In addition, it is necessary in the document, especially because of the different and fluctuating value of the pressing pressure of the compression spring on the connection collar of the sealing bellows, to specially cover and protect the corresponding edge of the sealing bellows with a circumferential metal sleeve. This is complicated and expensive, on the one hand, and, on the other hand, compromises the sealing action between the sealing bellows and the ball pivot.

The compression spring is also subject to dynamic stress during each motion of the ball and socket joint because one of its ends is arranged at the joint housing, which must be taken into account in dimensioning the fatigue strength of the compression spring, and leads to a correspondingly more strongly dimensioned compression spring, or to corresponding cost increases because it is necessary to use a material of higher quality for the compression spring. Finally, the compression spring thus arranged also considerably compromises the maximum possible angular deflection of the ball and socket joint, because if the compression spring is pressed to a stop on one side, no further angular motion of the joint housing can take place in relation to the ball pivot in the particular pivoting direction.

### SUMMARY OF THE INVENTION

Against this background, the object of the present invention is to provide a ball and socket joint with a sealing bellows, with which the drawbacks of the state of the art can be overcome. In particular, the ball and socket joint shall be extraordinarily failure-proof even under extreme climatic conditions while manufacture at low cost shall be possible at the same time. The sagging of the sealing bellows shall be permanently prevented in a simple, but effective manner, and the tightness of the sealing bellows shall thus be permanently ensured in the area of the ball pivot.

The ball and socket joint according to the present invention comprises a sealing bellows and a joint housing with a bearing shell, wherein the joint ball of a ball pivot is able to be received in the joint housing or in the bearing shell in a slidingly movable manner. The ball pivot of the ball and socket joint has a shaft area, a neck area and a ball, and the sealing bellows is in contact with the surface of the ball pivot by means of a circumferential closing collar in the shaft area of the ball pivot.

The ball and socket joint is characterized according to the present invention in that an element, which is elastic in the axial direction of the pivot and is supported under prestress with a first contact surface on the ball pivot and with a second contact surface indirectly or directly on the closing collar of the sealing bellows, is arranged within the sealing bellows.

In other words, this means that an elastic element, which may be a compression spring element, but which, in particular, is not supported at the edge of the joint housing, as in the state of the art, is present according to the present invention. The entire compression spring element is rather arranged according to the present invention directly at the ball pivot and is supported on the ball pivot.

Very many advantages are associated with this. At first, the dynamic load on the compression spring element is completely eliminated in this manner. The compression spring element is rather prestressed exclusively statically thanks to the present invention. The nonuniform distribution of the pressing force of the compression spring element in the area of the connection collar of the sealing bellows in different angular positions of the ball and socket joint is also eliminated with the present invention. The pressing force of the compression spring element remains, instead, equal on the connection collar of the sealing bellows under all operating conditions of the ball and socket joint and is uniformly distributed over the entire circumference of the connection collar. This is advantageously beneficial for the tightness of the sealing bellows and consequently the service life of the ball and socket joint.

In addition, it is possible thanks to the present invention to exactly coordinate the interaction of the elasticities of the sealing bellows and of the compression spring element by design measures such that optimal mechanical properties of the ball and socket joint will always be associated with optimal sealing properties of the sealing bellows. In particular, it is possible to exactly counteract the axial sagging of the sealing bellows or the reduction over time of the pressing pressure of the front side of the sealing bellows at the lever holder due to diverse external or physical factors such as angular deflection of the joint, aging, relaxation, temperature change, high-pressure cleaners, etc., in a determined manner by design measures by the compression spring element being dimensioned correspondingly.

Since the pivot-side connection collar of the ball pivot is pressed onto the lever holder in the axial direction of the pivot by an exactly definable, constant pressing pressure, which is uniform all round, thanks to the compression spring element according to the present invention, the pivot-side sealing of the sealing bellows can be better controlled and dimensioned by design measures, on the one hand. On the other hand, it is possible in this manner to use especially the axial front side of the pivot-side closing collar of the sealing bellows for the sealing task in a defined manner. Thus, besides the radial contact between the pivot-side closing collar on the shaft of the ball pivot, precisely the axial front side of this closing collar is also available for the pivot-side sealing between the sealing bellows and the ball pivot.

These two sealing planes, i.e., the axial contact of the pivot-side closing collar on the lever holder and the radial contact of the pivot-side closing collar with the ball pivot, make possible, taken together, a considerably improved seal between the sealing bellows and the ball pivot. This is all the more true as this area of the seal of a ball and socket joint is an especially critical area of the seal because of the relative rotary mobility that is necessary here between the sealing bellows and the ball pivot.

In addition, only the intended task proper of establishing a permanently sealed and elastic connection between the two seat surfaces of the bellows at the joint housing and at the ball pivot shaft is left for the jacket surface of the ball and socket joint as a consequence of the compression spring element being arranged according to the present invention. Without the compression spring element arranged according to the present invention, the axial force necessary for maintaining the shape of the sealing bellows and the position of the closing collar is applied by the sealing bellows itself by means of the corresponding shaping of the sealing bellows in most of the ball and socket joints known from the state of the art. This is also the reason why the sealing bellows typically has an onion shape in the state of the art. The jacket length is comparatively short in the case of this onion shape while the external diameter of the sealing bellows is relatively large.

However, this ratio can be optimized when the task of applying axial forces is eliminated for the sealing bellows. The jacket surface of the sealing bellows can then be shaped much more freely. For example, it is possible to use a jacket shape that tends to be cylindrical, the sealing bellows either having a greater length at equal external diameter or a smaller external diameter at equal length. The shaping of the sealing bellows can thus also be better adapted to the particular conditions of the environment and the design requirements, for example, the angular deflection or the space available for the installation of the joint.

Moreover, the thickness of the jacket surface of the sealing bellows can be reduced compared to conventional sealing bellows because of the elimination of the task of applying axial forces. The reduced material consumption associated herewith represents not only a resources-sparing environmental and cost aspect, but the radial tensile forces acting on the pivot-side connection collar of the sealing bellows, which occur during the angular motion of the joint, are rather also reduced in this manner. The great variations in the forces acting on the radial sealing surface between the bellows and the ball pivot, which variations have frequently occurred in the state of the art so far, can thus also be reduced and uncoupled from the angular motions, which in turn has a favorable effect on the service life of the seal and hence of the entire joint.

Another advantage of the arrangement of the compression spring element according to the present invention is that existing ball and socket joints can be retrofitted to the style of construction according to the present invention without any modification on their respective components. Only the additional compression spring element is arranged on the ball pivot in the manner according to the present invention for this purpose in an existing ball and socket joint.

Following the inventive idea, a variant may be that a compression spring element that is elastic in the axial direction of the pivot is arranged in the neck area of the ball pivot. The compression spring element advantageously has two essentially ring-shaped contact surfaces in the area of its two ends, and the compression spring element can be supported, for example, with the first contact surface, in the area of the transition between the neck area and the ball of the ball pivot. Indirect or direct supporting on the closing collar of the sealing bellows is meaningful with the second contact surface.

How the compression spring element is shaped and of what materials the compression spring element consists are not relevant for the embodiment of the present invention as long as the particular compression spring element makes possible the defined application of a force to the pivot-side closing collar of the sealing bellows, which application of force is constant for a long time. For example, essentially hollow cylindrical or hollow conical compression spring elements made of elastic polymer materials are thus conceivable as well. According to an especially preferred embodiment of the present invention, the compression spring element is, however, designed as a compression spring made of steel.

A steel compression spring can be manufactured at a low cost with a great variety of properties, but especially with spring rates that can be exactly specified. Furthermore, a compression spring made of steel has the great advantage that no relaxation will practically occur even in the long term, and the pressing forces specified by the design and hence also the sealing properties of at least the axial sealing surface of the sealing bellows remain constant over the entire service life of the ball and socket joint.

The present invention is embodied regardless of the precision with which the compression spring element is supported with its ball-side contact surface on the ball pivot as long as the support takes place according to the present invention on the ball pivot rather than on the joint housing, as in the state of the art. Thus, it is conceivable, for example, that the compression spring element is supported on a collar extending peripherally in a ring-shaped pattern, which is arranged in the neck area of the ball pivot. According to a preferred embodiment of the present invention, the compression spring element is supported, however, directly on the joint ball of the ball pivot, doing so directly at the transition between the neck area and the ball of the ball pivot. Support directly on the ball is both especially reliable and can be embodied by especially simple design measures, because no changes are thus necessary on the ball pivot.

According to another embodiment of the present invention, a ring element is arranged between the second, pivot-side contact surface of the compression spring element and the closing collar of the sealing bellows. The ring element especially preferably consists of a viscoplastic material with low coefficient of friction, for example, a thermoplastic polyurethane. Such a ring element is especially advantageous when the ball element is subject to frequent or permanent rotary angular motion. Permanent sliding motions may occur in such a case between both the pivot-side connection collar of the sealing bellows and the ball pivot and between the pivot-side contact surface of the compression spring element and the pivot-side connection collar of the sealing bellows.

Depending on the nature of the pivot-side contact surface of the compression spring element, these sliding motions may lead over time to damage to the corresponding opposite surface on the inner side of the sealing bellows. However, such damage can be avoided with the ring element in a simple and advantageous manner. In addition, the easy motion of the ball and socket joint and the low friction between the pivot-side connection collar of the sealing bellows and the ball pivot can thus be further improved.

According to an alternative embodiment of the present invention, the second contact surface of the compression spring element, i.e., the pivot-side contact surface of the compression spring element, comes directly into contact with the closing collar of the sealing bellows. This embodiment is characterized especially by the simplest design imaginable and hence by especially low manufacturing costs, along with unchanged effectiveness. A possible wear on the corresponding contact surface of the sealing bellows can be prevented in this case, for example, by designing the contact surface of the compression spring element correspondingly as a smooth surface or by jointly using a metal reinforcement of the sealing bellows, which is integrated by vulcanization and may possibly be present in the area of the pivot-side closing collar of the sealing bellows anyway, as a contact surface for the compression spring element.

According to another embodiment of the present invention, no straining ring is present in the area of the pivot-side closing collar of the sealing bellows and/or in the area of the contact between the sealing bellows and the joint housing. The embodiment without straining ring in the area of the pivot-side closing collar shall be pointed out, in particular. This embodiment has various advantages. Thus, both manufacturing and installation costs are saved due to the elimination of the straining ring. Furthermore, the risk of incorrect installation or of damage to the bellows during the mounting of the straining ring, as a result of which failures of ball and socket joints are still frequently caused in the state of the art, is completely eliminated as well.

The ball and socket joint has according to the present invention the compression spring element described, by which the axial front surface of the pivot-side closing collar of the sealing bellows is pressed onto the corresponding opposite surface, for example, in the area of the lever holder. As was already described, an additional effective axial sealing can be created as a result in the area in which the ball pivot and the sealing bellows pass through, which [axial sealing] relieves the radial seal between the sealing bellows and the ball pivot. This also contributes to the possibility of advantageously eliminating especially the pivot-side straining ring, which is offered by the present invention.

It is also advantageous in this connection, as this is provided for according to another embodiment of the present invention, if the axial front surface of the pivot-side closing collar of the sealing bellows has a structural sealing surface especially with a defined geometry, for example, a labyrinth gland or one or more sealing lips. As a result, the sealing action of the axial contact between the surface in the area of the lever holder and the axial front surface of the sealing bellows is further improved and can, moreover, be controlled by design measures and can be influenced in a purposeful manner.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a first embodiment of a ball and socket joint with a sealing bellows according to the present invention in a cut-away side view;

FIG. 2 is an enlarged view corresponding to FIG. 1 showing the area of the sealing bellows of the ball and socket joint according to FIG. 1;

FIG. 3 is a view in a layout and view corresponding to FIG. 2 showing another embodiment of a ball and socket joint according to the present invention;

FIG. 4 is a view in a layout and view corresponding to FIGS. 2 and 3 showing a third embodiment of a ball and socket joint according to the present invention;

FIG. 5 is a view in a layout and view corresponding to FIGS. 2 through 4 showing a fourth embodiment of a ball and socket joint according to the present invention; and

FIG. 6 is a view in a layout corresponding to FIG. 1 showing a fifth embodiment of a ball and socket joint according to the present invention.

### DESCRIPTION OF THE PREFERRED EMBODIMENTS

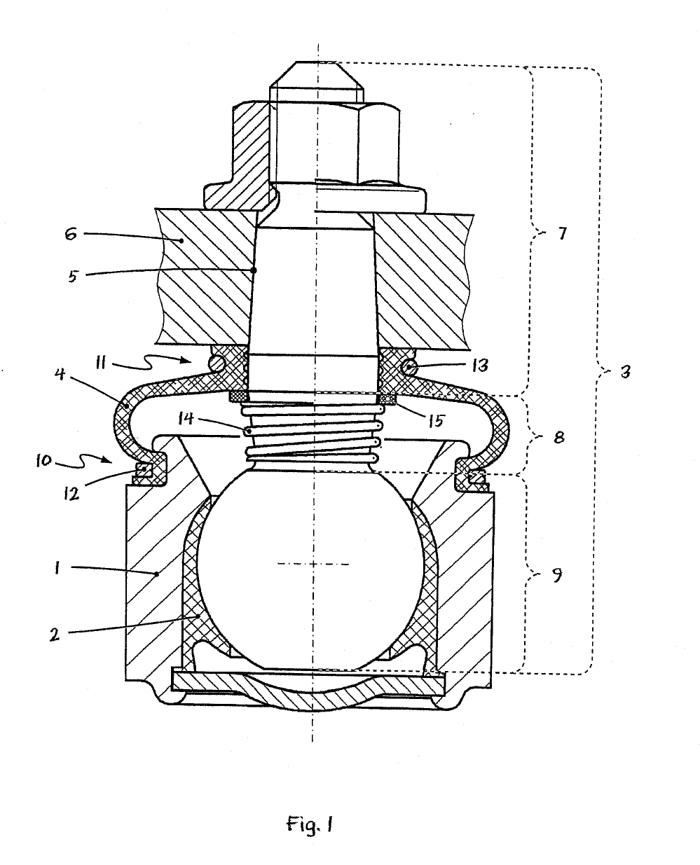

Referring to the drawings in particular, FIG. 1 shows a first embodiment of a ball and socket joint according to the present invention. The essential components of the ball and socket joint, namely, a joint housing 1 with a bearing shell 2 arranged therein as well as a ball pivot 3 and a sealing bellows 4 can be recognized at first. The ball pivot 3 is screwed, for example, to the lever holder 5 of a push rod 6 or the like in the area of the ball pivot 3 that is the upper area in the drawing. However, reference number 6 may also be a chassis component, for example, a suspension arm or an axle component, e.g., a drag bearing, a wheel carrier or the like. The ball pivot 3 is composed of a shaft area 7, a neck area 8 and a ball 9.

It is recognized, furthermore, that the sealing bellows 4 has two connection collars 10, 11, which form the connections of the sealing bellows 4 in the area of the joint housing 1 and in the shaft area 7 of the ball pivot 3. In the exemplary embodiment being shown, the two connection collars 10, 11 have a straining ring 12, 13 each, which support the intrinsic elasticity of the sealing bellows 4 and ensure reliable seating of the connection collars 10, 111 on the joint housing 1 and the ball pivot 3.

Finally, FIG. 1 also shows the compression spring element according to the present invention, which is in the form of a slightly conical compression coil spring 14 in this exemplary embodiment being shown. The compression coil spring 14 is supported with its contact surface, which is its lower contact surface in the drawing, or with its lower end, directly in the transition between the neck area 8 and the ball 9 of the ball pivot 3. The compression coil spring 14 is supported with its contact surface, which is the upper contact surface in the drawing, or its upper end, against a ring element 15, which transmits the pressing force of the compression coil spring 14 to the connection collar 11 of the sealing bellows 4, which said connection collar is the upper connection collar in the drawing. In addition, the ring element 15 protects the connection collar 11 of the sealing bellows 4 during relative rotary motions between the ball pivot 3 or the compression coil spring 14 and the sealing bellows 4 from being damaged by the end of the compression coil spring 14, which is the upper end in the drawing.

Because of the protective action of the compression coil spring 14, the sagging of the upper connection collar 11 of the sealing bellows 4 is avoided permanently and with a reliability that can be set exactly by design measures. The compression coil spring 14, located completely in the interior of the ball and socket joint, is already protected now optimally, and thus it does not need to be subjected to surface treatment against corrosion, which in turn saves costs.

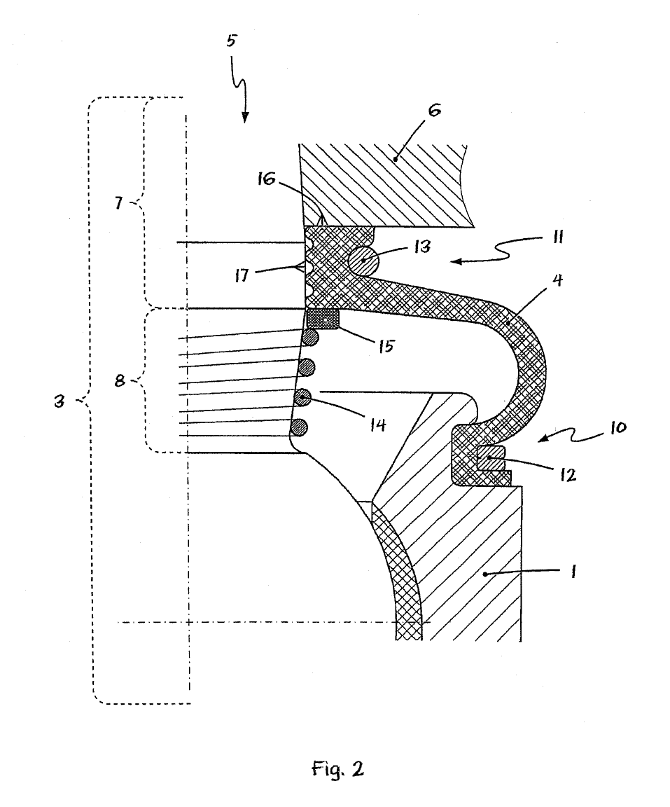

FIG. 2 shows an enlarged detail from the section through the ball and socket joint according to FIG. 1. Besides a part of the ball pivot 3, especially the sealing bellows 4 secured with the two straining rings 12, 13 as well as the compression coil spring 14 and the ring element 15 are recognized. It can also be recognized based on the view in FIG. 2 that the pressing pressure of the compression coil spring 14 in the area of the axial front surface 16 of the sealing bellows 4, which is the upper front surface in the drawing, ensures an additional effective sealing of the pivot-side connection collar 11 against the push rod 6 in the area of the lever holder 5. The radial seal 17 between the connection collar 11 and the shaft area 7 of the ball pivot 3 is thus supported and relieved.

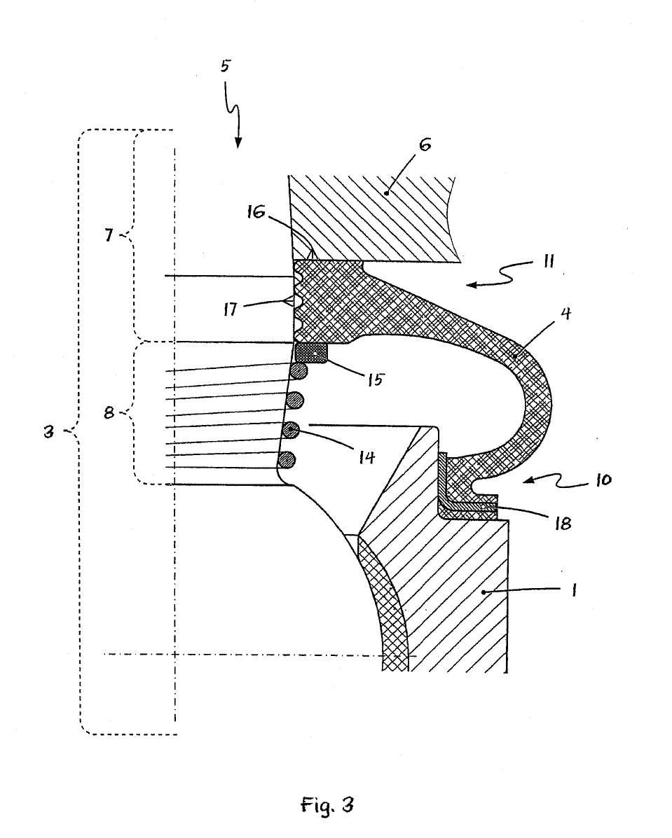

It can now be recognized from an examination of FIG. 3 that, in particular, the pivot-side straining ring 13 (cf. FIG. 2) can also be eliminated in an advantageous manner, because costs are thus saved, precisely because of the pressing pressure at 16 on the pivot-side connection collar 11 of the sealing bellows 4, which said pressing pressure is ensured by the compression coil spring 14, since, due to the pressing pressure, the axial contact surface 16 of the sealing bellows 4 already forms a defined seal on the surface of the push rod 6, and this defined seal effectively supports the radial seal 17 of the connection collar 11 on the shaft 7 of the ball pivot 3. As a result, it is also possible to eliminate the corresponding straining ring 13, without limitations of the sealing action at 16, 17 being associated herewith compared to a ball and socket joint without a compression spring element 14 according to the present invention.

Besides the pivot-side straining ring 13 (cf. FIG. 2), the housing-side straining ring 12 (cf. FIG. 2) was, furthermore, also eliminated in the embodiment according to FIG. 3. The task of that straining ring is assumed in the embodiment according to FIG. 3 by a metal sleeve 18, which is integrated by vulcanization in the housing-side connection collar 10 and extending circumferentially in a ring-shaped pattern. The metal sleeve 18 ensures the defined and permanently fixed seating of the housing-side connection collar 10 on the joint housing 1.

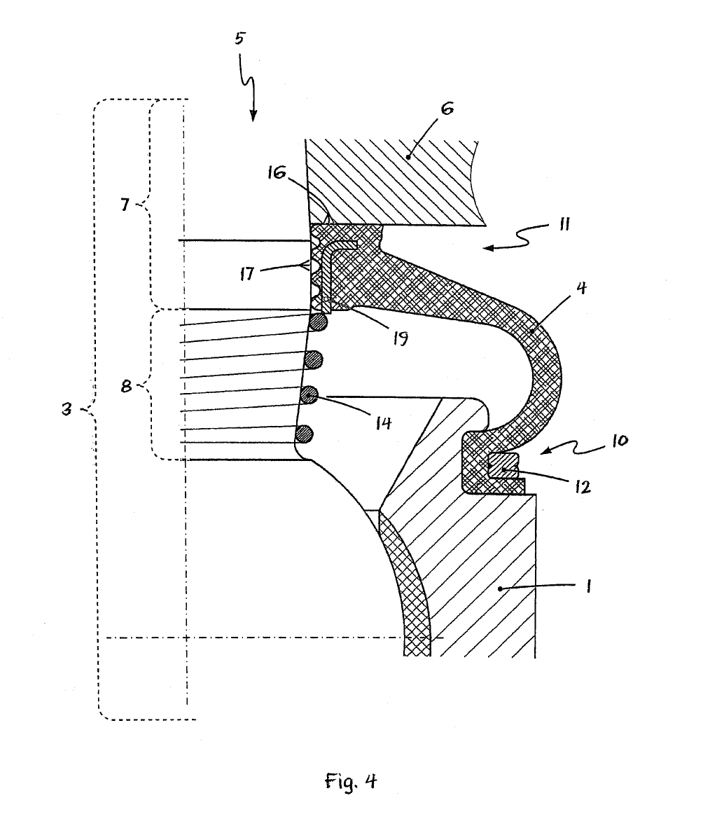

An embodiment that is simplified even more in terms of the design of the compression spring arrangement according to the present invention is shown in FIG. 4. It is seen that the ring element 15 (cf. FIG. 3) was also eliminated in the embodiment according to FIG. 4. The modifications on the ball and socket joint, which are necessary for embodying the present invention, are thus reduced to the additional installation of the compression coil spring 14. A metal sleeve 19, which may possibly already be present and is vulcanized into the pivot-side connection collar 11, can now completely replace the function of the eliminated ring element 15 by the compression coil spring 14 being in contact with the metal sleeve 19 integrated by vulcanization. Damage to or wear on the pivot-side connection collar 11 because of relative rotary motions between the ball pivot 3 or the compression coil spring 14 and the sealing bellows 4 is reliably prevented from occurring in this manner as well.

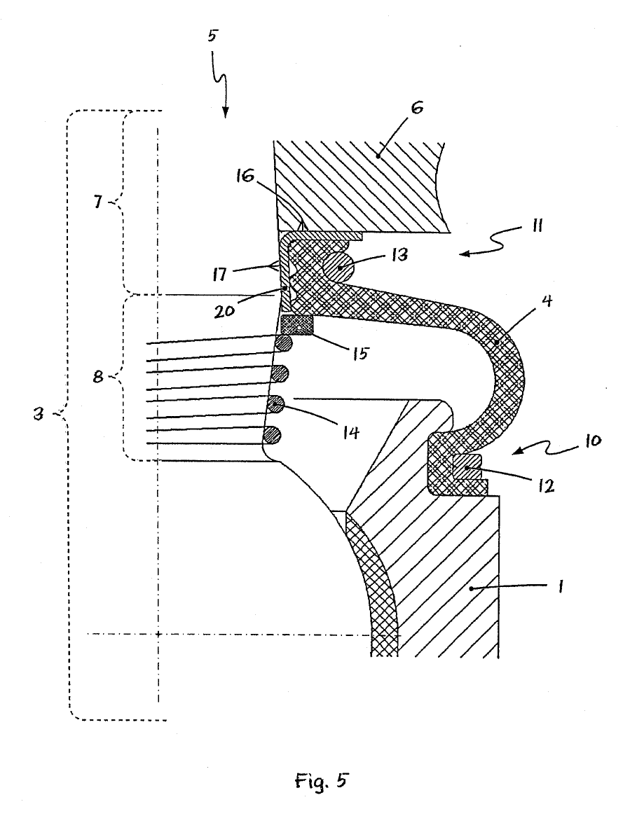

FIG. 5 shows another embodiment of a ball and socket joint according to the present invention. The embodiment according to FIG. 5 closely follows the embodiment according to FIG. 2 and differs herefrom primarily by the ball race 20 having an L-shaped cross section. The ball race 20, which consists, for example, of a corrosion-resistant special steel, is arranged between the pivot-side sealing collar 11 of the sealing bellows 4 and the bearing surface 17 in the shaft area 7 of the ball pivot 3 or in the area of the front surface 16 on the lever holder 5. The ball race 20 has the task of guiding the pivot-side connection collar of the sealing bellows accurately and with easy motion. A potentially abrasive chafing of the pivot-side connection collar on the ball pivot shaft 17 or at 16 on the connection component 6 is prevented from occurring thanks to the ball race 20 especially in ball and socket joints with especially frequent or permanent rotary angular motions. The compression spring element 14 arranged according to the present invention ensures a permanent, defined axial contact between the ball race 20 and the corresponding counterpart, here the connection component 6, for example, the lever holder, in this case as well.

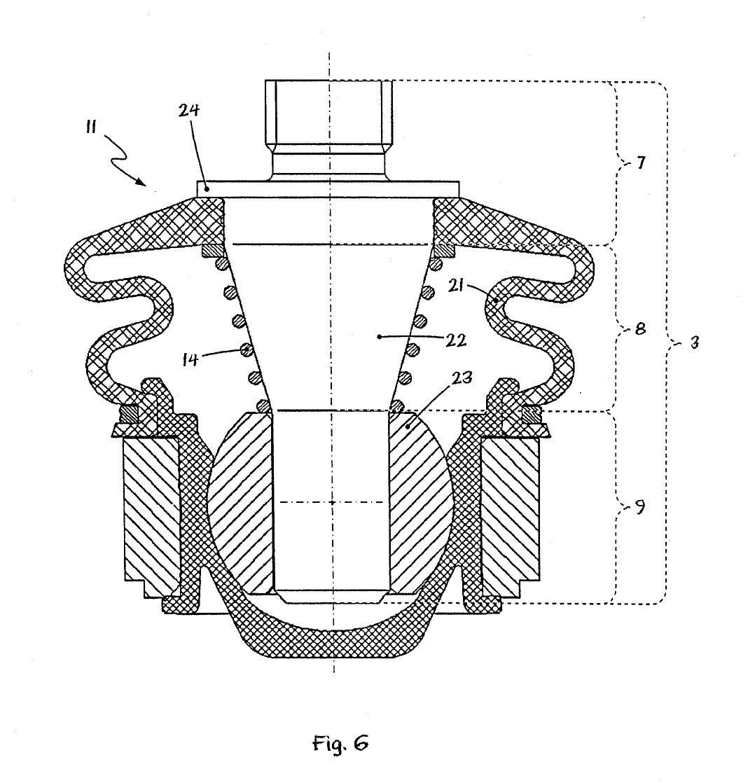

Finally, FIG. 6 shows another embodiment of a ball and socket joint according to the present invention with a sealing bellows and a compression spring element 14. It is recognized that the ball and socket joint according to FIG. 6 differs from the ball and socket joint according to FIG. 1 especially in that the ball and socket joint according to FIG. 6 has a bellows 21, on the one hand, and a two-part ball pivot 3, on the other hand. The two-part ball pivot 3 is composed of the pivot element 22 and the ball element 23, which are pressed together. However, the present invention can be used especially advantageously precisely in case of a bellows 21 and/or a ball and socket joint with a two-part ball pivot 3.

Namely, a bellows 21 is characterized, on the one hand, by especially high flexibility at especially weak restoring forces, but, on the other hand, by especially weak axial forces. It is therefore necessary to secure the pivot-side connection collar 11 of the bellows 21 especially effectively and carefully against the undesired axial sagging on the shaft 7 and on the neck 8 of the ball pivot 3. This happens according to the state of the art mostly in such a form that the pivot-side connection collar 11 of the bellows 21 is guided axially on both sides by a groove milled at 11 into the shaft area 7 of the ball pivot 3.

Both the preparation of the pivot groove and the mounting of the connection collar 11 in the groove are, however, complicated, cause additional costs and represent a potential source of error during manufacture. Thanks to the permanent and exactly dimensionable axial support of the pivot-side connection collar 11 of the bellows 21, which is made possible by the present invention, it is, however, possible to replace the hitherto necessary pivot groove by a simple axial stop or shoulder 24. Together with the action of the compression spring element 14, the axial shoulder 24 fully assumes the task of the hitherto necessary pivot groove.

This is especially advantageous in the ball and socket joint shown in FIG. 6 with the two-part ball pivot 3, 22, 23, because, thanks to the replacement of the pivot groove, which was previously to be prepared by machining, by the cooperation of the axial shoulder 24 and the compression spring element 14, the pivot element 22 of the ball pivot 3 can now be manufactured in one piece without machining, which both saves manufacturing costs and also improves the quality and the load-bearing capacity of the ball pivot 3.

Thus, it becomes clear as a result that, thanks to the present invention, the reliability and the failure safety of ball and socket joints can be improved in a quite surprisingly elementary, simple and cost-saving manner. The sagging of the sealing bellows is permanently prevented from occurring thanks to the present invention even under extreme climatic conditions or under extraordinary loads, for example, in case of exposure to the water jet of a high-pressure cleaner.

Thus, the present invention makes an essential contribution to the improvement of the absence of maintenance, service life, easy motion and safety of ball and socket joints, especially in case of demanding applications in the motor vehicle.

While specific embodiments of the invention have been shown and described in detail to illustrate the application of the principles of the invention, it will be understood that the invention may be embodied otherwise without departing from such principles.

1. A ball and socket joint comprising:
a joint housing;
a bearing shell disposed in said housing;
a ball pivot with a joint ball, said joint ball of said ball pivot being accommodated in a slidingly movable manner in said bearing shell, said ball pivot having a shaft area, a neck area and said joint ball;
a sealing bellows having a circumferential closing collar, which is indirectly or directly in contact with said shaft area of said ball pivot; and
an element, which is elastic in the axial direction of the pivot and is supported under prestress on said ball pivot with a first contact surface and indirectly or directly on said closing collar of said sealing bellows (4) with a second contact surface, said element being arranged within said sealing bellows.

2. A ball and socket joint in accordance with claim 1, wherein said element is a compression spring element.

3. A ball and socket joint in accordance with claim 2, wherein said compression spring element is a compression coil spring made of steel.

4. A ball and socket joint in accordance with claim 1, wherein said element has a ring-shaped contact surface each in the area of one of its two ends.

5. A ball and socket joint in accordance with claim 1, wherein said element is in contact by one of its contact surfaces in the area of a transition between said neck area and said joint ball or directly with said joint ball of said ball pivot.

6. A ball and socket joint in accordance with claim 1, wherein said sealing bellows is in contact by said circumferential closing collar with said surface of said ball pivot.

7. A ball and socket joint in accordance with claim 1, further comprising a ring element arranged between said second contact surface of said element and said closing collar of said sealing bellows.

8. A ball and socket joint in accordance with claim 1, wherein said ring element consists of a viscoplastic material with low coefficient of friction.

9. A ball and socket joint in accordance with claim 1, wherein said second contact surface of said element comes directly into contact with said closing collar of said sealing bellows.

10. A ball and socket joint in accordance with claim 1, further comprising: a straining ring present in the area of said closing collar of said sealing bellows on said shaft of the ball pivot and/or in the area in which said sealing bellows is in contact with said joint housing.

11. A ball and socket joint in accordance with claim 1, wherein said front surface of said pivot-side closing collar of said sealing bellows has a sealing surface.

12. A ball and socket joint in accordance with claim 1, wherein said ring element comprises a thermoplastic polyurethane.

13. A ball and socket joint comprising:
a joint housing;
a bearing shell in said housing;
a ball pivot with a joint ball, said joint ball being accommodated in a slidingly movable manner in said bearing shell, said ball pivot having a shaft area, a neck area adjacent to said joint ball;
a sealing bellows having a circumferential closing collar and
an axially elastic element arranged within said sealing bellows and supported under prestress on said ball pivot and including a first contact surface and a second contact surface acting on said closing collar of said sealing bellows.

14. A ball and socket joint in accordance with claim 13, wherein:
said axially elastic element is compression coil spring made of steel;
said first contact surface of said axially elastic element is a ring-shaped; and
said second contact surface is ring-shaped.

15. A ball and socket joint in accordance with claim 14, wherein second contact surface contacts an area of a transition between said neck area and said joint ball or directly with said joint ball.

16. A ball and socket joint in accordance with claim 15, further comprising: a ring element arranged between said second contact surface and said closing collar of said sealing bellows.

17. A ball and socket joint in accordance with claim 15, wherein said second contact surface is directly in contact with said closing collar of said sealing bellows.

18. A ball and socket joint in accordance with claim 15, further comprising: a straining ring in the area of said closing collar of said sealing bellows and/or in the area in which said sealing bellows is in contact with said joint housing.

19. A ball and socket joint in accordance with claim 15, wherein a front surface of a pivot-side closing collar of said sealing bellows has a sealing surface.
